(19) United States
(12) Patent Application Publication
(10) Pub. No.: US 2020/0301429 A1
(43) Pub. Date: Sep. 24, 2020

(54) VEHICLE CONTROL DEVICE

(71) Applicant: HONDA MOTOR CO., LTD., Tokyo (JP)

(72) Inventors: Hideki Matsunaga, Wako-shi (JP); Tokitomo Ariyoshi, Wako-shi (JP)

(73) Assignee: HONDA MOTOR CO., LTD., Tokyo (JP)

(21) Appl. No.: 16/822,351

(22) Filed: Mar. 18, 2020

(30) Foreign Application Priority Data
Mar. 20, 2019 (JP) 2019-052462

(51) Int. Cl. G05D 1/02

(52) U.S. Cl. CPC G05D 1/0212; G05D 2201/0213; G05D 2201/0212; G05D 1/0246

(57) ABSTRACT

A vehicle control device determines whether a plurality of other vehicles exist or not in a first specified region, acquires first inter-vehicle distances in a traveling direction and a vehicle width direction between the plurality of other vehicles, in case where the plurality of other vehicles exist in the first specified region, recognizes a set of other vehicles between which the first inter-vehicle distances are within a specified range, as one other-vehicle group, and controls driving of an host vehicle based on a first vehicle velocity Vcar1 of the one other-vehicle group.

### CROSS REFERENCES TO RELATED APPLICATIONS

The present application claims priority under 35 U.S.C. § 119 to Japanese Patent Application No. 2019-052462, filed Mar. 20, 2019, entitled “Vehicle Control Device.” The contents of this application are incorporated herein by reference in their entirety.

### BACKGROUND

### 1. Field

The present disclosure relates to a vehicle control device that controls driving conditions of an host vehicle in accordance with driving conditions of other vehicles surrounding the host vehicle.

### 2. Description of the Related Art

Conventionally, a vehicle control device disclosed in Japanese Patent No. 5511984 has been known. In the vehicle control device, an ON/OFF state of adaptive cruise control is switched by a technique that will be described below. That is, a maximum gradient value is calculated by a single regression analysis technique for acceleration spectrum based on an acceleration of an host vehicle and a minimum covariance value is calculated by a Gaussian distribution technique based on inter-vehicle distances to other vehicles surrounding the host vehicle. Then a correlation map representing relation between a logarithm of the maximum gradient value and a logarithm of the minimum covariance value is produced and presence or absence of a critical region in a traffic flow is determined based on the correlation map. In accordance with a result of such a determination, the ON/OFF state of the adaptive cruise control is switched.

According to the conventional vehicle control device, increase in the number of data demanded for operation may cause increase in operation load and operation time because the single regression analysis technique for the acceleration spectrum and the Gaussian distribution technique are used for acquisition of driving conditions of other vehicles surrounding the host vehicle. The greater the number of the other vehicles is, the more remarkable this trend becomes.

### SUMMARY

The present application describes a vehicle control device that may reduce an operation load and operation time for acquisition of driving conditions of other vehicles surrounding an host vehicle and that may improve controllability for the host vehicle.

In order to attain the above, a vehicle control device 1 according to a first aspect of the embodiment is characterized by including: a surrounding situation data acquisition unit/an acquisition device (situation detection device 4) that acquires surrounding situation data indicating a surrounding situation in a traveling direction of an host vehicle 3; a first other-vehicle determination unit/determinator (ECU 2, STEP 3) that determines whether a plurality of first other vehicles exist or not in a first specified region located at or farther than a specified distance from the host vehicle 3 in the traveling direction of the host vehicle 3, based on the surrounding situation data; a first driving condition acquisition unit (ECU 2, STEP 21) that, in case where the plurality of first other vehicles (other vehicles 20a to 20d) exist in the first specified region, acquires driving conditions of the plurality of first other vehicles, the driving conditions including first inter-vehicle distances in the traveling direction and a vehicle width direction between the plurality of first other vehicles, based on the surrounding situation data; a first other-vehicle group recognition unit/recognizer (ECU 2, STEP 21) that recognizes and select a set of the first other vehicles between which the first inter-vehicle distances are within a specified range, among the plurality of first other vehicles, so as to define the set of vehicles one group as if they are one single large vehicle composing of first other-vehicles (which is also referred to as “one first other-vehicle group” 20A); and a control unit/controller (ECU 2, STEPS 7 to 9) that controls driving such as conditions/operations of the host vehicle 3, based on driving conditions of the one first other-vehicle group.

According to the vehicle control device, whether the plurality of first other vehicles exist or not in the first specified region located at or farther than the specified distance from the host vehicle in the traveling direction of the host vehicle is determined based on the surrounding situation data indicating the surrounding situation in the traveling direction of the host vehicle and, if the plurality of first other vehicles exist in the first specified region, the driving conditions of the plurality of first other vehicles including the first inter-vehicle distances between the plurality of first other vehicles are acquired based on the surrounding situation data. The set of the first other vehicles between which the first inter-vehicle distances are within the specified range, among the plurality of first other vehicles, is recognized as the one first other-vehicle group and the driving conditions of the host vehicle are controlled based on the driving conditions of the one first other-vehicle group.

In this case, the one first other-vehicle group is the set of the first other vehicles between which the first inter-vehicle distances are within the specified range, among the plurality of first other vehicles existing in the first specified region. Thus an operation load and operation time for the control over the driving conditions of the host vehicle may be reduced in comparison with recognition of each in the set of the first other vehicles as one vehicle. As a result, the controllability may be improved.

The disclosure according to a second aspect of the embodiment may be characterized in that, in the vehicle control device 1 according to the first aspect of the embodiment, the first driving condition acquisition unit further acquires, as the driving conditions of the one first other-vehicle group, either of a velocity of the first other vehicle nearest to the host vehicle 3 in the one first other-vehicle group and an average velocity of the one first other-vehicle group as a first vehicle velocity Vcar1 (STEPS 24 and 41) and in that the control unit controls the driving conditions of the host vehicle 3, based on the first vehicle velocity Vcar1.

According to the vehicle control device, either of the velocity of the first other vehicle nearest to the host vehicle in the one first other-vehicle group and the average velocity of the plurality of first other vehicles is further acquired as the first vehicle velocity and the driving conditions of the host vehicle are controlled based on the first vehicle velocity. On condition that the velocity of the first other vehicle nearest to the host vehicle in the one first other-vehicle group is acquired as the first vehicle velocity, time demanded for acquisition of the first vehicle velocity may be made all the shorter because the velocity of the one first other vehicle has only to be acquired as the first vehicle velocity. As a result, responsiveness in drive control over the host vehicle may be improved.

On condition that the average velocity of the one first other-vehicle group is acquired as the first vehicle velocity, the first vehicle velocity may be acquired with reduction of a variation in velocity among the first other vehicles, in comparison with the acquisition of the velocity of the one first other vehicle as the first vehicle velocity. As a result, stability in the drive control over the host vehicle may be improved.

The disclosure according to a third aspect of the embodiment may be characterized in that the vehicle control device 1 according to the second aspect of the embodiment further includes: a second other-vehicle determination unit/determinator (ECU 2, STEP 5) that determines whether a second other vehicle other than the plurality of first other vehicles exists or not in a second specified region located nearer than the specified distance from the host vehicle 3 in the traveling direction of the host vehicle 3, based on the surrounding situation data; and a second vehicle velocity acquisition unit (ECU 2, STEP 53) that acquires a second vehicle velocity Vcar2 that is a velocity of the second other vehicle (other vehicle 22b) in case where the second other vehicle exists in the second specified region, and in that the control unit controls the driving conditions of the host vehicle 3, based on the first vehicle velocity Vcar1, on condition that the second other vehicle is located nearer than the one first other-vehicle group and that the first vehicle velocity Vcar1 is lower than the second vehicle velocity Vcar2 (STEPS 7 to 9 and 62).

According to the vehicle control device, the second vehicle velocity that is the velocity of the second other vehicle is acquired on condition that the second other vehicle exists in the second specified region and the driving conditions of the host vehicle are controlled based on the first vehicle velocity on condition that the second other vehicle is located nearer than the one first other-vehicle group and that the first vehicle velocity is lower than the second vehicle velocity. In this case, the second specified region is nearer to the host vehicle than the first specified region. Therefore, in case where the first vehicle velocity of the first other-vehicle group existing in the first specified region farther than the second other vehicle is lower than the second vehicle velocity of the second other vehicle, it is assumed that the velocity of the second other vehicle will decrease to the first vehicle velocity in near future. Thus the driving conditions of the host vehicle are controlled based on the first vehicle velocity, so that smooth driving conditions may be ensured while abrupt deceleration of the host vehicle is avoided.

The disclosure according to a fourth aspect of the embodiment may be characterized in that, in the vehicle control device 1 according to the third aspect of the embodiment, in case where a plurality of second other vehicles exist in the second specified region, the second vehicle velocity acquisition unit acquires a velocity of the second other vehicle nearest to the host vehicle 3 among the plurality of second other vehicles, as the second vehicle velocity Vcar2 (STEPS 51 to 53).

According to the vehicle control device, in case where the plurality of second other vehicles exist in the second specified region, the velocity of the second other vehicle nearest to the host vehicle among the plurality of second other vehicles is acquired as the second vehicle velocity. In this case, it may be assumed that the second other vehicle nearest to the host vehicle may exert a greater influence upon the host vehicle than the second other vehicle existing farther does. Therefore, an operation load for such acquisition may be reduced by preferential acquisition of only the velocity of the second other vehicle nearest to the host vehicle as the second vehicle velocity, in comparison with an operation load for acquisition of velocities of the plurality of second other vehicles.

The disclosure according to a fifth aspect of the embodiment may be characterized in that, in the vehicle control device 1 according to the third or fourth aspect of the embodiment, the surrounding situation data acquisition unit includes: an image data acquisition unit (situation detection device 4) that acquires the surrounding situation data in the first specified region, as image data; and a second specified region data acquisition unit (situation detection device 4) that has a data acquisition capability at distances shorter than distances for the image data acquisition unit and that acquires the surrounding situation data in the second specified region, as second specified region data, in that the first other-vehicle determination unit determines whether the plurality of first other vehicles exist or not in the first specified region, based on the image data, and in that the second other-vehicle determination unit/determinator determines whether the second other vehicle exists or not in the second specified region, based on the second specified region data.

It is generally known that, among techniques for recognition of an object remote from an host vehicle, image recognition techniques with use of image data may enable recognition of a farther object than recognition techniques based on distance measurement or the like. On the contrary, it is known that the recognition techniques based on the distance measurement or the like may enable more accurate recognition of an object in a region near to the host vehicle. According to the vehicle control device, therefore, whether the plurality of first other vehicles exist in the first specified region or not is determined based on the image data and thus the first specified region may be set farther than such a region for the recognition techniques based on the distance measurement or the like. On the other hand, whether the second other vehicle exists or not in the second specified region is determined based on the second specified region data and thus use of LIDAR or the like for distance measurement, for instance, as the second specified region data acquisition unit may enable more accurate acquisition of the second specified region data than use of the image data acquisition unit as the second specified region data acquisition unit does.

The disclosure according to a sixth aspect of the embodiment may be characterized in that the vehicle control device 1 according to the first aspect of the embodiment includes: an other-vehicle determination unit/determinator (ECU 2, STEPS 28, 29, and 40 to 42) that, in case where the first other-vehicle group exists in an object lane in which the host vehicle 3 is driving and a first lane that is any of a plurality of adjoining lanes adjoining the object lane, determines whether a plurality of other vehicles other than the first other-vehicle group exist or not in a second lane located at a specified distance in the vehicle width direction from the first lane in the first specified region, based on the surrounding situation data; a second driving condition acquisition unit (ECU 2, STEPS 28, 29, and 40 to 42) that, in case where the plurality of other vehicles exist in the second lane, acquires driving conditions of the plurality of other vehicles, the driving conditions including second inter-vehicle distances in the traveling direction between the plurality of other vehicles, based on the surrounding situation data; a second other-vehicle group recognition unit/recognizer (ECU 2, STEPS 28, 29, and 40 to 42) that recognizes the plurality of other vehicles, as one second other-vehicle group, in case where the second inter-vehicle distances are within the specified range; and an extending direction determination unit/determinator (ECU 2, STEP 43) that determines whether extending directions of the first lane and the second lane are same as an extending direction of the object lane or not, and in that, in case where the extending direction of the object lane is same as the extending direction of either of the first lane and the second lane and different from the extending direction of the other of the first lane and the second lane, the control unit controls the driving conditions of the host vehicle 3, based on the driving conditions of either (other-vehicle group 21A) of the first other-vehicle group and the second other-vehicle group that is located in the either of the first lane and the second lane (STEPS 7 to 9 and 41).

According to the vehicle control device, the driving conditions of the plurality of second other vehicles that include the second inter-vehicle distances in the traveling direction between the plurality of other vehicles are acquired based on the surrounding situation data, in case where the first other-vehicle group exists in the object lane and the first lane that is any of the plurality of adjoining lanes and where the plurality of other vehicles exist in the second lane located at the specified distance in the vehicle width direction from the first lane in the first specified region, and the plurality of other vehicles are recognized as the one second other-vehicle group, in case where the second inter-vehicle distances are within the specified range. Furthermore, whether the extending directions of the first lane and the second lane are same as the extending direction of the object lane or not is determined and, in case where the extending direction of the object lane is same as the extending direction of either of the first lane and the second lane and different from the extending direction of the other of the first lane and the second lane, the driving conditions of the host vehicle are controlled based on the driving conditions of either of the first other-vehicle group and the second other-vehicle group that is located in the either of the first lane and the second lane.

In case where either of the first other-vehicle group and the second other-vehicle group exists in the lane extending in the same direction as the extending direction of the object lane and where the other exists in the lane extending in a direction different from the extending direction of the object lane, it may be assumed that the other-vehicle group existing in the lane extending in the same direction as the extending direction of the object lane may exert a greater influence upon the host vehicle than the other-vehicle group existing in the lane extending in the direction different from the extending direction of the object lane. Thus the driving conditions of the host vehicle are controlled based on the driving conditions of the other-vehicle group that may exert the greater influence upon the host vehicle, so that the controllability may be improved.

The disclosure according to a seventh aspect of the embodiment may be characterized in that, in the vehicle control device 1 according to the first or second aspect of the embodiment, the surrounding situation data acquisition unit carries out data communication between the host vehicle 3 and other vehicles including the plurality of first other vehicles and in that the first other-vehicle determination unit/determinator determines whether the plurality of first other vehicles exist or not in the first specified region, based on a result of the data communication.

According to the vehicle control device, whether the plurality of first other vehicles exist in the first specified region or not is determined based on the result of the data communication with the other vehicles and thus presence or absence of the plurality of first other vehicles may be determined even under conditions that the presence or absence of the plurality of first other vehicles cannot be determined by image recognition or the like, for instance.

The disclosure according to an eighth aspect of the embodiment may be characterized in that the vehicle control device 1 according to the first aspect of the embodiment further includes: an host vehicle location acquisition unit (situation detection device 4) that acquires a current location of the host vehicle 3; a map data acquisition unit (situation detection device 4) that acquires map data indicating a traffic environment surrounding the current location of the host vehicle 3; a branch road determination unit/determinator (ECU 2, STEP 25) that determines whether a branch road branching off from a lane in which the host vehicle 3 is driving and either of adjoining lanes adjoining the lane exists in the first specified region or not, based on the map data; a lane determination unit/determinator (ECU 2, STEP 25) that determines whether the one first other-vehicle group is driving or not in a lane connected to the branch road, in case where the branch road exists; and a traffic environment acquisition unit (ECU 2, STEP 1) that acquires a traffic environment other than the driving conditions of the one first other-vehicle group, based on the map data and the surrounding situation data, in case where the one first other-vehicle group is driving in the lane connected to the branch road, and in that the control unit controls the driving conditions of the host vehicle 3, based on the traffic environment other than the driving conditions of the one first other-vehicle group (STEPS 7 to 9 and 63).

According to the vehicle control device, the current location of the host vehicle and the map data indicating the traffic environment surrounding the current location of the host vehicle are acquired and whether the branch road branching off from the lane in which the host vehicle is driving and either of the adjoining lanes adjoining the lane exists in the first specified region or not is determined based on the map data. In case where the branch road exists, whether the one first other-vehicle group is driving or not in the lane connected to the branch road is determined. In case where the one first other-vehicle group is driving in the lane connected to the branch road, the traffic environment other than the driving conditions of the one first other-vehicle group is acquired based on the map data and the surrounding situation data and the driving conditions of the host vehicle are controlled based on the traffic environment other than the driving conditions of the one first other-vehicle group.

In case where the one first other-vehicle group is driving in the lane connected to a branch road under a condition that the branch road exists in the first specified region, it is estimated that the one first other-vehicle group will drive toward the branch road, based on the map data. Thus the driving conditions of the host vehicle may be controlled independently of the driving conditions of the one first other-vehicle group. As a result, the driving conditions of the host vehicle may be controlled based on the traffic environment other than the driving conditions of the one first other-vehicle group, so that the operation load for the control may be reduced. The word “unit” used in this application may mean a physical part or component of computer hardware or any device including a controller, a processor, a memory, etc., which is particularly configured to perform functions and steps disclosed in the application.

### BRIEF DESCRIPTION OF THE DRAWINGS

FIG. 1 is a diagram schematically illustrating configurations of a vehicle control device according to an embodiment of the present disclosure and a vehicle to which the vehicle control device is applied.

FIG. 2 is a flow chart illustrating automated drive control processing.

FIG. 3 is a flow chart illustrating first acquisition processing.

FIG. 4 is a flow chart illustrating plurality acquisition processing.

FIG. 5 is a flow chart illustrating second acquisition processing.

FIG. 6 is a flow chart illustrating driving track determination processing.

FIG. 7 is a diagram schematically illustrating an example of a traffic environment in which other-vehicle groups exist in a first specified region and in which other vehicles exist in a second specified region.

FIG. 8 is a diagram illustrating an image of the traffic environment of FIG. 7 as seen looking from a side of an host vehicle.

FIG. 9 is a diagram schematically illustrating an example of a traffic environment in which a branch lane exists.

FIG. 10 is a diagram illustrating an image of the traffic environment of FIG. 9 as seen looking from the side of the host vehicle.

FIG. 11 is a diagram schematically illustrating an example of a traffic environment in which two other-vehicle groups exist in the first specified region.

### DESCRIPTION OF THE PREFERRED EMBODIMENTS

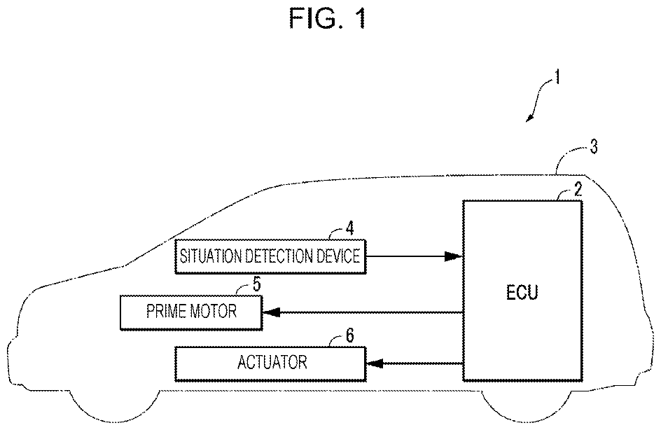

Hereinbelow, a vehicle control device according to an embodiment of the present disclosure will be described with reference to the drawings. As illustrated in FIG. 1, the vehicle control device 1 is applied to a four-wheel vehicle (which will be referred to as “host vehicle” below) 3 and includes an ECU 2. A situation detection device 4, a prime motor 5, and an actuator 6 are electrically connected to the ECU 2.

The situation detection device 4 is made of a camera, a millimeter-wave radar, LIDAR, a sonar, GPS, various sensors, a car navigation system, and the like. The situation detection device 4 acquires current location data, map data, and surrounding situation data and outputs these pieces of data to the ECU 2.

The current location data, representing a current location of the host vehicle 3, is acquired by the GPS. The map data, representing a map of surroundings of the current location of the host vehicle 3, is acquired based on the current location, from among map data stored in the car navigation system. In addition, under conditions that enable data communication between the car navigation system of the host vehicle 3 and car navigation systems of other vehicles, the data communication is carried out.

The surrounding situation data, representing a surrounding situation (such as a driving environment or traffic participants) in a traveling direction of the host vehicle 3, is configured so as to include image data acquired by the camera, measurement data acquired by the LIDAR or the like and representing distances and velocities, and the like.

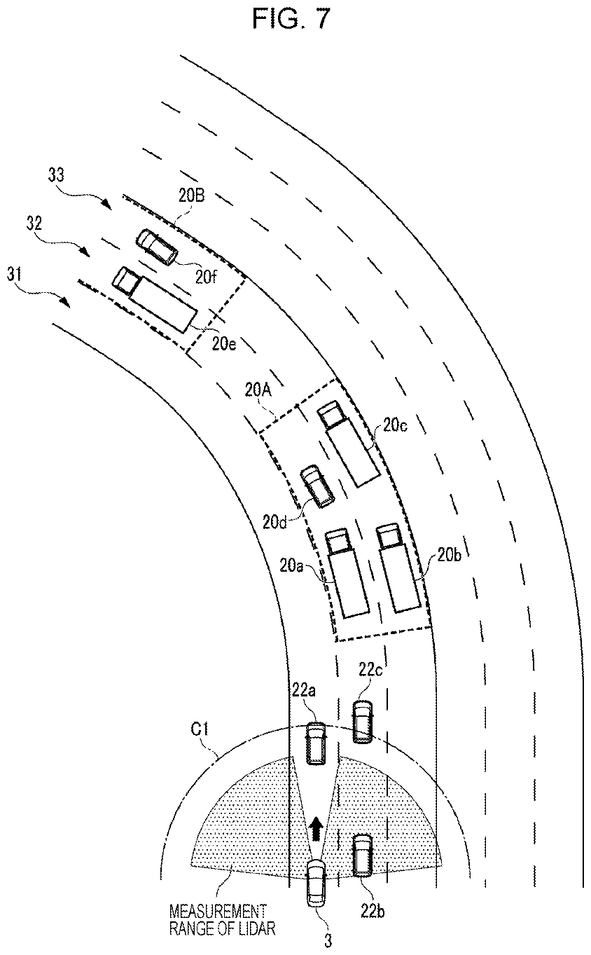

In this case, the LIDAR has a data measurement capability in a range (range on the order of tens of meters to a hundred meters from the host vehicle 3) stippled in FIG. 7, for instance, and the camera has an acquisition capability for image data in a range wider than the range of the LIDAR, for instance, in a range on hundreds of meters from the host vehicle 3.

In the embodiment, a region farther than an arc C1 illustrated by a chain line in FIG. 7 corresponds to a first specified region located at or farther than a specified distance from the host vehicle 3 and a region located inside the arc C1 and nearer to the host vehicle 3 than the arc C1 corresponds to a second specified region. When a portion of a vehicle exists inside the arc C1, it is assumed that the vehicle exists in the second specified region.

As will be described later, the ECU 2 recognizes the current location of the host vehicle 3 and a traffic environment or the like in the surroundings of the host vehicle 3, based on the current location data, the map data, data on communication with other vehicles, and the surrounding situation data from the situation detection device 4, and carries out automated drive control processing, based on results of such recognition.

In a description below, the current location data, the map data, data on communication with other vehicles, and the surrounding situation data will be collectively and appropriately referred to as “various kinds of data”. In the embodiment, the situation detection device 4 corresponds to a surrounding situation data acquisition unit, an image data acquisition unit, a second specified region data acquisition unit, an host vehicle location acquisition unit, and a map data acquisition unit.

The prime motor 5 is made of an electric motor or the like, for instance. Upon a determination of a driving track (that is, driving direction and velocity) of the host vehicle 3, as will be described later, output of the prime motor 5 is controlled by the ECU 2 so that the host vehicle 3 may drive on the driving track.

The actuator 6 is made of a braking actuator, a steering actuator, and the like. Upon the determination of the driving track of the host vehicle 3, as will be described later, operation of the actuator 6 is controlled by the ECU 2 so that the host vehicle 3 may drive on the driving track.

Meanwhile, the ECU 2 is made of a microcomputer including CPU, RAM, ROM, E2PROM, I/O interface, various electrical circuits (none of which is illustrated), and the like. As will be described below, the ECU 2 carries out the automated drive control processing or the like, based on the various kinds of data from the situation detection device 4 described above.

In the embodiment, the ECU 2 corresponds to a first other-vehicle determination unit, a first driving condition acquisition unit, a first other-vehicle group recognition unit, a control unit, a second other-vehicle determination unit, a second vehicle velocity acquisition unit, an other-vehicle determination unit, a second driving condition acquisition unit, a second other-vehicle group recognition unit, an extending direction determination unit, a branch road determination unit, a lane determination unit, and a traffic environment acquisition unit.

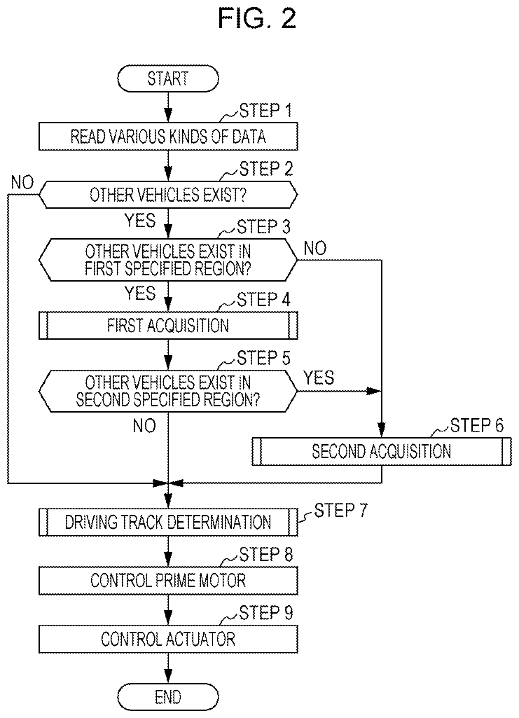

Subsequently, the automated drive control processing in the embodiment will be described with reference to FIG. 2. In the automated drive control processing, as will be described below, velocities of other vehicles are acquired and automated drive control over the host vehicle 3 is exercised in accordance with the velocities. The automated drive control processing is carried out by the ECU 2 pursuant to specified control cycles.

Initially, as illustrated in FIG. 2, the various kinds of data are read (FIG. 2/STEP 1). That is, the current location data, the map data, the data on the communication with other vehicles, and the surrounding situation data are read from the situation detection device 4 described above.

Subsequently, a determination is made as to whether any other vehicles exist in surroundings of the traveling direction of the host vehicle 3 or not, based on the surrounding situation data among the various kinds of data (FIG. 2/STEP 2). If the determination is negative (FIG. 2/STEP 2: NO), flow advances to driving track determination processing (FIG. 2/STEP 7) that will be described later.

On the other hand, if the determination is positive (FIG. 2/STEP 2: YES), that is, if any other vehicles exist in the surroundings of the traveling direction of the host vehicle 3, a determination is made as to whether any other vehicles exist in the first specified region or not, based on the surrounding situation data (FIG. 2/STEP 3).

If the determination is negative (FIG. 2/STEP 3: NO), that is, if the other vehicles exist only in the second specified region, the flow advances to second acquisition processing (FIG. 2/STEP 6) that will be described later. On the other hand, if the determination is positive (FIG. 2/STEP 3: YES), that is, if any other vehicles exist in the first specified region, first acquisition processing is carried out (FIG. 2/STEP 4).

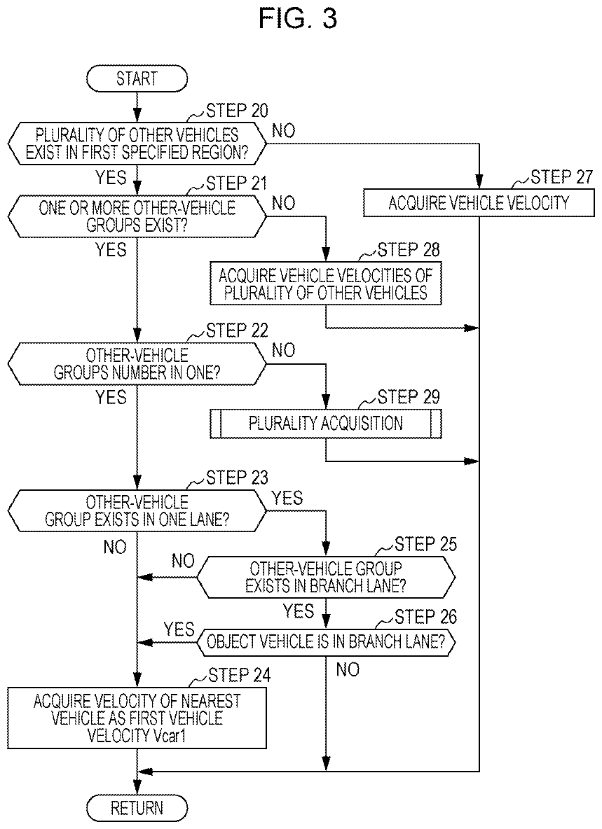

The first acquisition processing, in which the velocities of the other vehicles existing in the first specified region are acquired, is carried out as illustrated in FIG. 3, specifically. Initially, as illustrated in FIG. 3, a determination is made as to whether a plurality of other vehicles exist in the first specified region or not, based on the image data among the surrounding situation data (FIG. 3/STEP 20). In case where the data communication may be carried out between the car navigation system of the host vehicle 3 and the car navigation systems of other vehicles, the determination may be made based on the data on the communication among the various kinds of data.

If the determination is negative (FIG. 3/STEP 20: NO), that is, if only one other vehicle exists in the first specified region, the vehicle velocity of the one other vehicle is acquired (FIG. 3/STEP 27) and the present processing is ended.

On the other hand, if the determination is positive (FIG. 3/STEP 20: YES), that is, if the plurality of other vehicles exist in the first specified region, a determination is made as to whether one or more other-vehicle groups exist or not (FIG. 3/STEP 21). Specifically, all inter-vehicle distances in the traveling directions and the vehicle width directions between the plurality of other vehicles are acquired based on the image data among the surrounding situation data. If all the inter-vehicle distances in the traveling directions and the vehicle width directions between the other vehicles are within a specified range (within a range of several meters or less, for instance), the other vehicles are collectively recognized as one other-vehicle group.

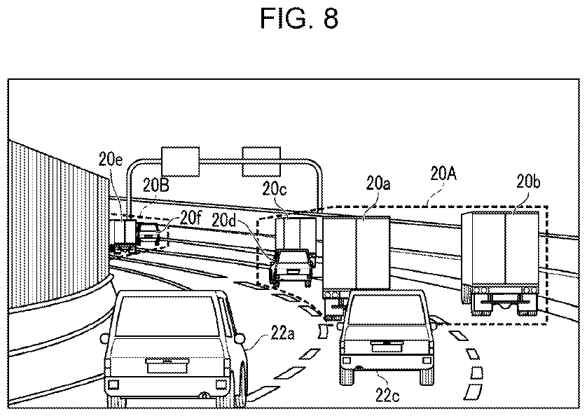

In this case, under a traffic environment where the host vehicle 3 is driving in a left lane 31 and where six other vehicles 20a to 20f exist in a center lane 32 and a right lane 33 in the first specified region, as illustrated in FIGS. 7 and 8, for instance, all inter-vehicle distances in the traveling directions and the vehicle width directions between four other vehicles 20a to 20d are within the specified range and thus the other vehicles 20a to 20d are recognized as one other-vehicle group 20A. Furthermore, two other vehicles 20e and 20f are recognized as another other-vehicle group 20B. Recognition of the other-vehicle groups described above may be made based on the data on the communication described above, instead of the image data.

Referring again to FIG. 3, if the above determination is negative (FIG. 3/STEP 21: NO), that is, if the plurality of other vehicles dispersively exist in the first specified region, the vehicle velocities of the plurality of other vehicles are acquired (FIG. 3/STEP 28) and the present processing is ended.

On the other hand, if the above determination is positive (FIG. 3/STEP 21: YES), that is, if the one or more other-vehicle groups exist in the first specified region, a determination is made as to whether the one or more other-vehicle groups number in one or not (FIG. 3/STEP 22). If the determination is positive (FIG. 3/STEP 22: YES), a determination is made as to whether the one other-vehicle group exists in one lane or not (FIG. 3/STEP 23). That is, the determination is made as to whether the plurality of other vehicles drive in a row in one lane or not.

If the determination is negative (FIG. 3/STEP 23: NO), that is, if a plurality of other vehicles in the one other-vehicle group are driving in different lanes, a velocity of the nearest vehicle is acquired as a first vehicle velocity Vcar1 (FIG. 3/STEP 24) and the present processing is ended. Here, the nearest vehicle is an other vehicle that is nearest to the host vehicle 3 in the one other-vehicle group. In case where the only one other-vehicle group 20A exists in FIG. 7, for instance, the other vehicle 20a falls under the nearest vehicle.

On the other hand, if the above determination is positive (FIG. 3/STEP 23: YES), that is, if the one other-vehicle group exists in one lane, a determination is made as to whether the one other-vehicle group exists in a branch lane or not (FIG. 3/STEP 25). The determination is made based on the map data and the surrounding situation data.

If the determination is negative (FIG. 3/STEP 25: NO), that is, if the one other-vehicle group does not exist in the branch lane, the velocity of the nearest vehicle is acquired as the first vehicle velocity Vcar1 (FIG. 3/STEP 24), as described above, and the present processing is ended.

On the other hand, if the above determination is positive (FIG. 3/STEP 25: YES), that is, if the one other-vehicle group exists in the branch lane, a determination is made as to whether the host vehicle 3 is driving in the branch lane or not (FIG. 3/STEP 26).

If the determination is positive (FIG. 3/STEP 26: YES), that is, if the host vehicle 3 is driving in the branch lane, the velocity of the nearest vehicle is acquired as the first vehicle velocity Vcar1 (FIG. 3/STEP 24), as described above, and the present processing is ended. Thus the host vehicle 3 drives in the branch lane while following the one other-vehicle group, as a result of execution of the driving track determination processing that will be described later and the like.

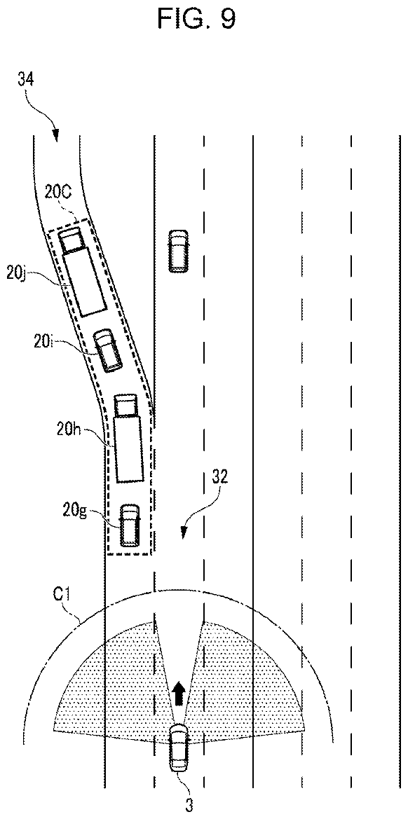

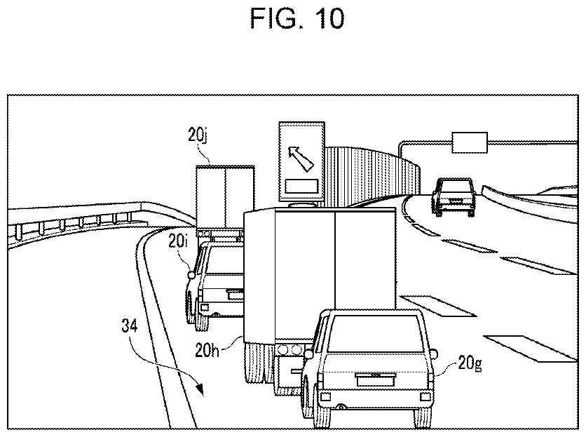

On the other hand, if the determination is negative (FIG. 3/STEP 26: NO), that is, if the host vehicle 3 is not driving in the branch lane, the present processing is directly ended. That is, acquisition of the vehicle velocity is omitted. The acquisition is omitted because, in case where the host vehicle 3 is driving in the uphill center lane 32 and where four other vehicles 20g to 20j are driving in an uphill branch lane 34 in the first specified region as illustrated in FIGS. 9 and 10, for instance, a possibility that an other-vehicle group 20C made of the other vehicles 20g to 20j may influence driving of the host vehicle 3 may be assumed to be low. In the embodiment, the branch lane 34 corresponds to a lane connected to a branch road and the other-vehicle group 20C corresponds to a first other-vehicle group.

On the other hand, if the determination described above is negative (FIG. 3/STEP 22: NO), that is, if a plurality of other-vehicle groups exist in the first specified region, plurality acquisition processing is carried out (FIG. 3/STEP 29).

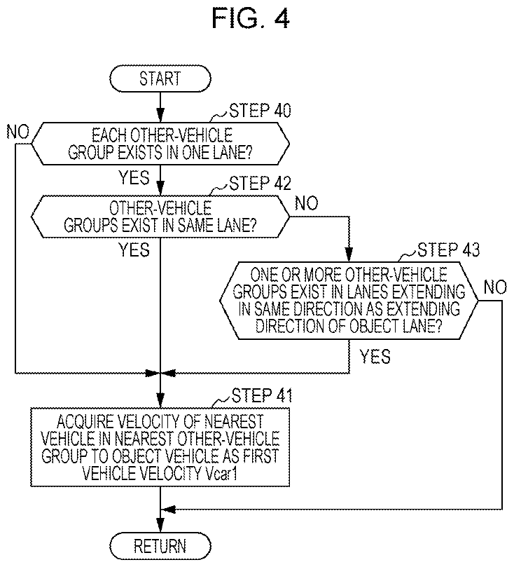

In the plurality acquisition processing, under a condition that the plurality of other-vehicle groups exist in the first specified region, a velocity of an other vehicle in the other-vehicle groups is acquired. Specifically, the plurality acquisition processing is carried out as illustrated in FIG. 4. Initially, as illustrated in FIG. 4, a determination is made as to whether each of the other-vehicle groups exists in one lane or not, based on the surrounding situation data (FIG. 4/STEP 40).

If the determination is negative (FIG. 4/STEP 40: NO), that is, if each of the other-vehicle groups does not exist in one lane, a velocity of a nearest vehicle in the nearest other-vehicle group to the host vehicle 3 is acquired as the first vehicle velocity Vcar1 based on the surrounding situation data (FIG. 4/STEP 41) and the present processing is ended.

In this case, if the two other-vehicle groups 20A and 20B exist in the first specified region as illustrated in FIG. 7 described above, for instance, a velocity of the nearest vehicle 20a in the other-vehicle group 20A is acquired as the first vehicle velocity Vcar1.

On the other hand, if the determination described above is positive (FIG. 4/STEP 40: YES), that is, if each of the other-vehicle groups exists in one lane, a determination is made as to whether the other-vehicle groups exist in the same lane or not (FIG. 4/STEP 42).

If the determination is positive (FIG. 4/STEP 42: YES), that is, if the other-vehicle groups exist in the same lane, the velocity of the nearest vehicle in the nearest other-vehicle group to the host vehicle 3 is acquired as the first vehicle velocity Vcar1 as described above (FIG. 4/STEP 41) and the present processing is ended.

On the other hand, if the above determination is negative (FIG. 4/STEP 42: NO), that is, if the other-vehicle groups do not exist in the same lane, a determination is made as to whether one or more other-vehicle groups exist in lanes extending in the same direction as an extending direction of an object lane or not (FIG. 4/STEP 43). The determination is made based on the current location data, the map data, and the surrounding situation data that have been described above.

If the determination is positive (FIG. 4/STEP 43: YES), that is, if one or more other-vehicle groups exist in the lanes extending in the same direction as the extending direction of the object lane, the velocity of the nearest vehicle in the nearest other-vehicle group to the host vehicle 3 is acquired as the first vehicle velocity Vcar1 as described above (FIG. 4/STEP 41) and the present processing is ended.

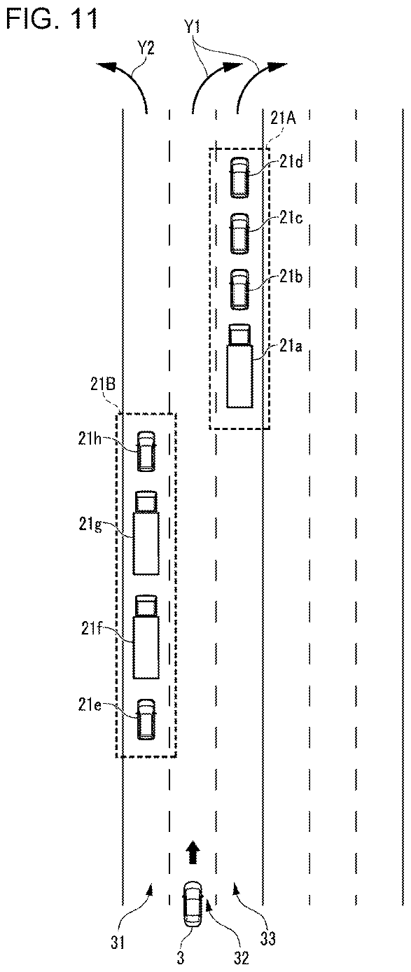

In this case, a traffic environment where the host vehicle 3 is driving in the center lane 32, where an other-vehicle group 21A made of four other vehicles 21a to 21d exists in a right lane 33, and where an other-vehicle group 21B made of four other vehicles 21e to 21h exists in a left lane 31 is assumed as illustrated in FIG. 11, for instance. Under the traffic environment, if the extending directions of the center lane 32 and the right lane 33 are the same, as illustrated by arrows Y1, and if the extending direction of the left lane 31 is different therefrom, as illustrated by an arrow Y2, it is determined that a possibility of the other-vehicle group 21B influencing the driving of the host vehicle 3 is low and a vehicle velocity of the other vehicle 21a that is the nearest vehicle in the other-vehicle group 21A is acquired as the first vehicle velocity Vcar1.

Referring again to FIG. 4, if the determination described above is negative (FIG. 4/STEP 43: NO) and if the one or more other-vehicle groups do not exist in the lanes extending in the same direction as the extending direction of the object lane, that is, if the other-vehicle group 21A does not exist but only the other-vehicle group 21B exists in FIG. 11, the present processing is directly ended.

Referring again to FIG. 3, the plurality acquisition processing (FIG. 3/STEP 29) is carried out as described above and the first acquisition processing is thereafter ended.

Referring again to FIG. 2, the first acquisition processing (FIG. 2/STEP 4) is carried out as described above and a determination is thereafter made as to whether any other vehicles exist in the second specified region or not, based on the measurement data among the surrounding situation data (FIG. 2/STEP 5). If the determination is negative (FIG. 2/STEP 5: NO), that is, if the other vehicles exist only in the first specified region, the flow advances to the driving track determination processing (FIG. 2/STEP 7) that will be described later.

On the other hand, if the above determination is positive (FIG. 2/STEP 5: YES), that is, if the other vehicles exist in the first and second specified regions, or if the determination described above is negative (FIG. 2/STEP 3: NO), that is, if the other vehicles exist only in the second specified region, the second acquisition processing is carried out (FIG. 2/STEP 6).

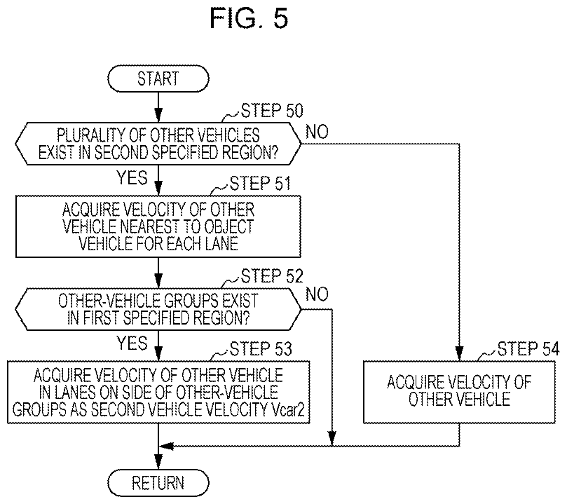

The second acquisition processing, in which the velocities of the other vehicles existing in the second specified region are acquired, is carried out as illustrated in FIG. 5, specifically. Initially, as illustrated in FIG. 5, a determination is made as to whether a plurality of other vehicles exist in the second specified region or not, based on the measurement data described above (FIG. 5/STEP 50).

If the determination is negative (FIG. 5/STEP 50: NO), that is, if only one other vehicle exists in the second specified region, the velocity of the other vehicle is acquired (FIG. 5/STEP 54) and the present processing is ended.

On the other hand, if the above determination is positive (FIG. 5/STEP 50: YES), that is, if the plurality of other vehicles exist in the second specified region, a velocity of the other vehicle that is nearest to the host vehicle 3 is acquired for each lane (FIG. 5/STEP 51).

In this case, under a traffic environment where the host vehicle 3 is driving in the left lane 31, where one other vehicle 22a exists in the left lane 31 in the second specified region, and where two other vehicles 22b and 22c exist in the center lane 32, as illustrated in FIG. 7, for instance, velocities of the other vehicles 22a and 22b are acquired, while a velocity of the other vehicle 22c is not acquired. On condition that an inter-vehicle distance between the other vehicle 22c and the other vehicle 20a ahead of the other vehicle 22c is within the specified range described above under the traffic environment illustrated in FIG. 7, the other vehicle 22c and the other vehicles 20a to 20d described above may be collectively recognized as the other-vehicle group 20A.

Subsequently, a determination is made as to whether any other-vehicle groups exist in the first specified region or not (FIG. 5/STEP 52). If the determination is negative (FIG. 5/STEP 52: NO), that is, if no other-vehicle groups exist in the first specified region, the present processing is directly ended.

On the other hand, if the above determination is positive (FIG. 5/STEP 52: YES), that is, if any other-vehicle groups exist in the first specified region, a velocity of an other vehicle in lanes on a side of the other-vehicle groups is acquired as a second vehicle velocity Vcar2 (FIG. 5/STEP 53) and the present processing is ended. In this case, under the traffic environment illustrated in FIG. 7, a velocity of the other vehicle 22b is acquired as the second vehicle velocity Vcar2.

Referring again to FIG. 2, if the second acquisition processing has been carried out as described above, if no other vehicles exist in the second specified region, or if no other vehicles exist in the first and second specified regions, the driving track determination processing is carried out (FIG. 2/STEP 7).

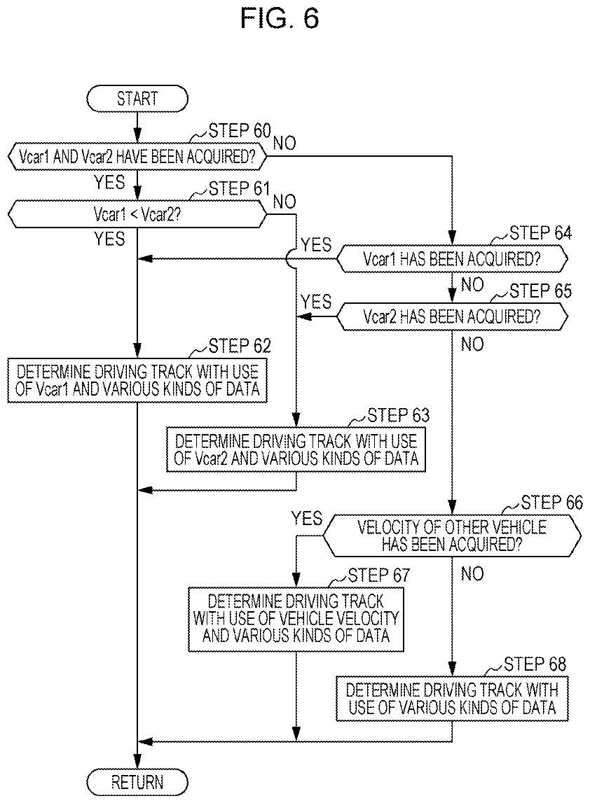

The driving track determination processing, in which the driving direction and velocity of the host vehicle 3 are determined as the driving track of the host vehicle 3, is carried out as illustrated in FIG. 6, specifically. Initially, as illustrated in FIG. 6, a determination is made as to whether both the first vehicle velocity Vcar1 and the second vehicle velocity Vcar2 described above have been acquired or not (FIG. 6/STEP 60).

If the determination is positive (FIG. 6/STEP 60: YES), a determination is made as to whether Vcar1<Vcar2 holds or not (FIG. 6/STEP 61). If the determination is positive (FIG. 6/STEP 61: YES), that is, if the velocity of the other-vehicle group in the first specified region is lower than the velocity of the other vehicle located in the second specified region nearer than the first specified region, the driving track is determined with use of the first vehicle velocity Vcar1 and the various kinds of data (FIG. 6/STEP 62).

This determination is made because, in case where the velocity of the other-vehicle group in the first specified region is lower than the velocity of the other vehicle located in the second specified region, it may be assumed that the velocity of the other vehicle located in the second specified region will decrease promptly. After the driving track, that is, the driving direction and the velocity of the host vehicle 3 are determined as described above, the present processing is ended.

On the other hand, if the above determination is negative (FIG. 6/STEP 61: NO), that is, if the velocity of the other-vehicle group in the first specified region is equal to or higher than the velocity of the other vehicle located in the second specified region nearer than the first specified region, the driving track is determined with use of the second vehicle velocity Vcar2 and the various kinds of data (FIG. 6/STEP 63). The present processing is thereafter ended.

On the other hand, if the determination described above is negative (FIG. 6/STEP 60: NO), a determination is made as to whether the first vehicle velocity Vcar1 has been acquired or not (FIG. 6/STEP 64).

If the determination is positive (FIG. 6/STEP 64: YES), that is, if no other vehicles exist in the lanes on the side of the other-vehicle groups in the second specified region in a state in which the other-vehicle groups exist in the first specified region, the driving track is determined with use of the first vehicle velocity Vcar1 and the various kinds of data, as described above (FIG. 6/STEP 62). The present processing is thereafter ended.

On the other hand, if the above determination is negative (FIG. 6/STEP 64: NO), a determination is made as to whether the second vehicle velocity Vcar2 has been acquired or not (FIG. 6/STEP 65).

If the determination is positive (FIG. 6/STEP 65: YES), the driving track is determined with use of the second vehicle velocity Vcar2 and the various kinds of data, as described above (FIG. 6/STEP 63). The present processing is thereafter ended.

On the other hand, if the determination described above is negative (FIG. 6/STEP 65: NO), a determination is made as to whether a vehicle velocity of any other vehicle has been acquired or not (FIG. 6/STEP 66).

If the determination is positive (FIG. 6/STEP 66: YES), the driving track is determined with use of the acquired vehicle velocity and the various kinds of data (FIG. 6/STEP 67). The present processing is thereafter ended.

On the other hand, if the above determination is negative (FIG. 6/STEP 66: NO), that is, if no other vehicles exist in the first and second specified regions, the driving track of the host vehicle 3 is determined in accordance with the various kinds of data (FIG. 6/STEP 68). The present processing is thereafter ended.

Referring again to FIG. 2, the driving track determination processing is carried out as described above and the prime motor 5 is thereafter controlled so that the host vehicle 3 may drive on the determined driving track (that is, the driving direction and the velocity of the host vehicle 3) (FIG. 2/STEP 8).

Subsequently, the actuator 6 is controlled so that the host vehicle 3 may drive on the driving track (FIG. 2/STEP 9). The present processing is thereafter ended.

According to the vehicle control device 1 of the embodiment, as described above, the determination is made as to whether a plurality of other vehicles exist in the first specified region or not, based on the image data among the surrounding situation data. If the plurality of other vehicles exist in the first specified region, the inter-vehicle distances between the plurality of other vehicles are acquired and a set of other vehicles between which the inter-vehicle distances in the traveling directions and the vehicle width directions are within the specified range, among the plurality of other vehicles, is recognized as one other-vehicle group. If a plurality of other-vehicle groups exist, the velocity of the nearest vehicle in the one nearest other-vehicle group to the host vehicle 3 is acquired as the first vehicle velocity Vcar1.

The determination is made as to whether any other vehicle exists in the second specified region or not, based on the measurement data among the surrounding situation data and, if any other vehicle exists in the lanes on the side of the other-vehicle groups in the second specified region, the velocity of the other vehicle is acquired as the second vehicle velocity Vcar2. If the first vehicle velocity Vcar1 is lower than the second vehicle velocity Vcar2, driving conditions of the host vehicle 3 are controlled based on the first vehicle velocity Vcar1. In this case, the second specified region is nearer to the host vehicle 3 than the first specified region. Therefore, if the velocity of the other-vehicle group existing in the specified region farther than the second other vehicle is lower than the velocity of the second other vehicle, it is assumed that the velocity of the second other vehicle will decrease to the velocity of the other-vehicle group in near future. Thus the driving conditions of the host vehicle 3 are controlled based on the vehicle velocity, so that smooth driving conditions may be ensured while abrupt deceleration of the host vehicle 3 may be avoided.

In addition, the velocity of the vehicle nearest to the host vehicle 3 among the one other-vehicle group is acquired as the first vehicle velocity Vcar1 and thus time demanded for acquisition of the velocity may be shortened in comparison with acquisition of the velocities of all the vehicles in the one other-vehicle group. As a result, responsiveness in drive control over the host vehicle 3 may be improved.

If a plurality of other vehicles exist in the second specified region nearer than the other-vehicle group, the velocity of the other vehicle nearest to the host vehicle 3 is acquired as the second vehicle velocity Vcar2. In this case, it may be assumed that the second other vehicle nearest to the host vehicle 3 may exert a greater influence upon the host vehicle 3 than the second other vehicles existing farther do. Therefore, an operation load for the acquisition may be reduced by preferential acquisition of only the velocity of the second other vehicle as the second vehicle velocity, in comparison with the operation load for the acquisition of velocities of the plurality of second other vehicles.

Furthermore, the determination as to whether any other vehicles exist in the first specified region or not is made based on the image data acquired by the camera and the determination as to whether any other vehicles exist in the second specified region or not is made based on the measurement data acquired by the LIDAR or the like. Thus the determination as to whether any other vehicles exist in the first specified region or not may be made accurately and the determination of presence or absence of other vehicles in the first specified region that is immeasurable by such a device with short measurable distance as LIDAR may be made accurately.

In addition, in case where one other-vehicle group and another other-vehicle group exist in different lanes, the driving conditions of the host vehicle 3 are controlled based on the first vehicle velocity Vcar1 of the other-vehicle group existing in a lane extending in the same direction as the extending direction of the lane of the host vehicle 3. Thus the driving conditions of the host vehicle 3 may be controlled based on the velocity of the other-vehicle group that may exert the greater influence upon the host vehicle 3, so that controllability may be improved.

In case where the data communication with other vehicles may be carried out, the determination may be made as to whether a plurality of first other vehicles exist in the first specified region or not, based on a result of the communication. Consequently, presence or absence of the plurality of first other vehicles may be determined even under conditions that the presence or absence of the plurality of first other vehicles cannot be determined by image recognition or the like, for instance.

In case where one other-vehicle group is driving in a lane connected to a branch road under a condition that the branch road exists in the first specified region, it may be estimated the one first other-vehicle group will drive toward the branch road, based on the map data or the like. Therefore, the driving conditions of the host vehicle 3 may be controlled independently of driving conditions of the one first other-vehicle group, so that an operation load for the control may be reduced.

Though the embodiment represents an example in which the velocity of the nearest vehicle in the one other-vehicle group is acquired as the first vehicle velocity Vcar1, an average velocity of all the vehicles in the other-vehicle group may be acquired as the first vehicle velocity Vcar1, alternatively. In this configuration, the first vehicle velocity Vcar1 may be acquired with reduction of a variation in velocity among the other vehicles, in comparison with the acquisition of the velocity of the one nearest vehicle as the first vehicle velocity Vcar1. As a result, stability in velocity control over the host vehicle 3 may be improved.

Though the embodiment represents an example in which the vehicle control device of the present disclosure is applied to the host vehicle 3 that is driven by the automated drive control, the vehicle control device of the present disclosure may be applied to a vehicle that is driven with switching between the automated drive control and manual driving by a driver.

The embodiment further represents an example in which the other-vehicle groups are sets of other vehicles driving in lanes different from a driving lane for the host vehicle 3. In case where a plurality of other vehicles are driving in the driving lane for the host vehicle 3 and where inter-vehicle distances between the plurality of other vehicles may be acquired through the data communication with the other vehicles or the like, however, the other-vehicle groups may be configured so as to include the plurality of other vehicles driving in the driving lane for the host vehicle 3.

What is claimed is:

1. A vehicle control device for a host vehicle, comprising:
a surrounding situation data acquisition unit configured to acquire surrounding situation data indicating a surrounding situation in a traveling direction of the host vehicle;
a first other-vehicle determinator configured to determine whether a plurality of first other vehicles exist or not in a first specified region located at or farther than a specified distance from the host vehicle in the traveling direction of the host vehicle, based on the surrounding situation data;
a first driving condition acquisition unit configured to, in case where the plurality of first other vehicles exist in the first specified region, acquiring driving conditions of the plurality of first other vehicles, the driving conditions including first inter-vehicle distances between the plurality of first other vehicles in the traveling direction and in a vehicle width direction, respectively, based on the surrounding situation data;
a first other-vehicle group recognizer configured to select a set of the first other vehicles between which each of the first inter-vehicle distances is within a specified range, among the plurality of first other vehicles and define the set of the first other vehicles as a single group of the first other vehicles; and
a controller configured to control driving of the host vehicle, based on driving conditions of the single group of the first other vehicles.

2. The vehicle control device according to claim 1, wherein
the first driving condition acquisition unit further acquires, as the driving conditions of the single group of the first other vehicles, either of a velocity of the first other vehicle nearest to the host vehicle in the single group of the first other vehicles and an average velocity of the single group of the first other vehicles as a first vehicle velocity, and
the controller controls the driving of the host vehicle, based on the first vehicle velocity.

3. The vehicle control device according to claim 2, further comprising:
a second other-vehicle determinator configured to determine whether a second other vehicle other than the plurality of first other vehicles exists or not in a second specified region located nearer than the specified distance from the host vehicle in the traveling direction of the host vehicle, based on the surrounding situation data; and
a second vehicle velocity acquisition unit configured to acquire a second vehicle velocity that is a velocity of the second other vehicle in case where the second other vehicle exists in the second specified region, wherein
the controller controls the driving of the host vehicle, based on the first vehicle velocity, on condition that the second other vehicle is located nearer than the single group of the first other vehicles and that the first vehicle velocity is lower than the second vehicle velocity.

4. The vehicle control device according to claim 3, wherein
in case where a plurality of the second other vehicles exist in the second specified region, the second vehicle velocity acquisition unit acquires a velocity of the second other vehicle nearest to the host vehicle among the plurality of second other vehicles, as the second vehicle velocity.

5. The vehicle control device according to claim 3, wherein
the surrounding situation data acquisition unit comprises
an image data acquisition unit configured to acquire the surrounding situation data in the first specified region, as image data, and
a second specified region data acquisition unit that has a data acquisition capability at distances shorter than distances for the image data acquisition unit and that acquires the surrounding situation data in the second specified region, as second specified region data,
the first other-vehicle determinator determines whether the plurality of first other vehicles exist or not in the first specified region, based on the image data, and
the second other-vehicle determinator determines whether the second other vehicle exists or not in the second specified region, based on the second specified region data.

6. The vehicle control device according to claim 1, further comprising:
an other-vehicle determinator configured to, in case where the first other-vehicle group exists in an object lane in which the host vehicle is driving and a first lane that is any of a plurality of adjoining lanes adjoining the object lane, determine whether a plurality of other vehicles other than the first other-vehicle group exist or not in a second lane located at a specified distance in the vehicle width direction from the first lane in the first specified region, based on the surrounding situation data;
a second driving condition acquisition unit configured to, in case where the plurality of other vehicles exist in the second lane, acquire driving conditions of the plurality of other vehicles, the driving conditions including second inter-vehicle distances in the traveling direction between the plurality of other vehicles, based on the surrounding situation data;
a second other-vehicle group recognizer configured to recognize the plurality of other vehicles, as one second other-vehicle group, in case where the second inter-vehicle distances are within the specified range; and
an extending direction determinator configured to determine whether extending directions of the first lane and the second lane are same as an extending direction of the object lane or not, wherein
in case where the extending direction of the object lane is same as the extending direction of either of the first lane and the second lane and different from the extending direction of the other of the first lane and the second lane, the controller controls the driving of the host vehicle, based on the driving conditions of either of the first other-vehicle group and the second other-vehicle group that is located in the either of the first lane and the second lane.

7. The vehicle control device according to claim 1, wherein
the surrounding situation data acquisition unit carries out data communication between the host vehicle and other vehicles including the plurality of first other vehicles, and
the first other-vehicle determinator determines whether the plurality of first other vehicles exist or not in the first specified region, based on a result of the data communication.

8. The vehicle control device according to claim 1, further comprising:
an host vehicle location acquisition unit configured to acquire a current location of the host vehicle;
a map data acquisition unit configured to acquire map data indicating a traffic environment surrounding the current location of the host vehicle;
a branch road determinator configured to determine whether a branch road branching off from a lane in which the host vehicle is driving and either of adjoining lanes adjoining the lane exists in the first specified region or not, based on the map data;
a lane determinator configured to determine whether the single group of the first other vehicles is driving or not in a lane connected to the branch road, in case where the branch road exists; and
a traffic environment acquisition unit configured to acquire a traffic environment other than the driving conditions of the single group of the first other vehicles, based on the map data and the surrounding situation data, in case where the single group of the first other vehicles is driving in the lane connected to the branch road, wherein
the controller controls the driving of the host vehicle, based on the traffic environment other than the driving conditions of the single group of the first other vehicles.
